(19) United States
(12) Patent Application Publication
(10) Pub. No.: US 2007/0151159 A1
(43) Pub. Date: Jul. 5, 2007

(54) Universal carrier for window regulator

(75) Inventor: Shigeki Arimoto, Bloomfield Hills, MI (US)

Correspondence Address: YOUNG & BASILE, P.C., 3001 WEST BIG BEAVER ROAD, SUITE 624, TROY, MI, 48084, US

(73) Assignee: Hi-Lex Corporation, Troy, MI (US)

(21) Appl. No.: 11/321,521

(22) Filed: Dec. 29, 2005

(51) Int. Cl. E05F 11/48

(52) U.S. Cl. 49/352

(57) ABSTRACT

A carrier for a window regular. The regulator includes a vertical rail defining a vertical track, a glass carrier adapted to receive a lower edge of the window glass and mounted for vertical sliding movement along the track and a cable having an upper end terminating in an enlarged head and a lower end terminating in an enlarged head, the carrier having a lower receptacle proximate the lower region of the carrier receiving the head of the upper cable end with the upper cable end extending vertically upwardly therefrom, whereby upward pulling movement on the upper cable end moves the carrier upwardly along the track, and an upper receptacle proximate an upper region of the carrier receiving the head of the lower cable end with the lower cable end extending vertically downwardly therefrom, whereby downward pulling movement on the lower cable end moves the carrier downwardly along the track. The vertically upwardly extending upper cable end and the vertically downwardly extending lower cable end are vertically aligned, whereby they may pass each other in either left/right or right/left mix without substantial displacement of either cable end from its natural vertical position.

### FIELD OF THE INVENTION

This invention relates to window regulators and more particularly to window regulators for use in raising and lowering window glasses in motor vehicles.

### BACKGROUND OF THE INVENTION

One popular form of window regulator for motor vehicle use employs a vertical track in the vehicle door and a carrier slidable upwardly and downwardly on the track via a cable to raise and lower the carrier and thereby raise and lower the window glass. In order to apply cable power uniformly to the carrier, it is common practice to secure a lower end of the cable to an upper region of the carrier and secure an upper end of the cable to a lower region of the carrier with the result that the upper and lower cable ends cross each other. To avoid interference between the upper and lower cable ends the carriers are formed in a “handed” manner to provide separate and distinct routes for the upper and lower cable ends. However, this requires that differently “handed” carriers be provided to satisfy the window regulator requirements of a motor vehicle and further allows for the possibility of incorrect assembly with resultant interference between the upper and lower cable ends.

### SUMMARY OF THE INVENTION

This invention is directed to the provision of improved carrier for a window regulator.

More particularly this invention is directed to the provision of carrier for a window regulator that is not handed and therefore has universal applicability.

This invention relates to a window regulator for raising and lowering a window glass in a motor vehicle comprising a vertical rail defining a vertical track, a glass carrier adapted to receive a lower edge of a window glass and mounted for vertical sliding movement along the track, and a cable having an upper end terminating in an enlarged head and a lower end terminating in an enlarged head, the carrier having a lower receptacle proximate a lower region of the carrier receiving the head of the upper cable end with the upper cable end extending vertically upwardly therefrom, whereby upward pulling movement of the upper cable end moves the cable upwardly along the track, and an upper receptacle proximate an upper region of the carrier receiving the head of the lower cable end with the lower cable end extending vertically downwardly therefrom, whereby downward pulling movement of the lower cable end moves the carrier downwardly along the track. According to the invention, each receptacle includes a cable exit through which the cable end leaves the receptacle with the cable head positioned in the receptacle and the cable exits of the upper and lower receptacles are vertically aligned.

According to a further feature of the invention, the carrier further includes a cable guide groove interconnecting the upper and lower receptacle exits.

According to a further feature of the invention, the cable guide groove has a rhombus configuration.

According to a further feature of the invention, the cable guide groove, in side elevation, has a convex configuration.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a somewhat schematic view of the window regulator of the invention show in association with a motor vehicle door;

FIG. 2 is a perspective view of a carrier assembly utilized in the window regulator;

FIG. 3 is an exploded perspective view of the carrier assembly;

FIG. 4 is a perspective view of a slider forming a part of the carrier assembly;

FIG. 5 is an end view of the slider;

FIG. 6 is a view of one side of the slider;

FIG. 7 is a view of the other side of the slider;

FIGS. 8 and 9 are cross-sectional views taken on lines 8-8 and 9-9 of FIG. 5;

FIGS. 10 and 11 are fragmentary detail views of the slider; and

FIGS. 12 and 13 are views of a cable employed to power the slider.

### DETAILED DESCRIPTION OF THE PREFERRED EMBODIMENT

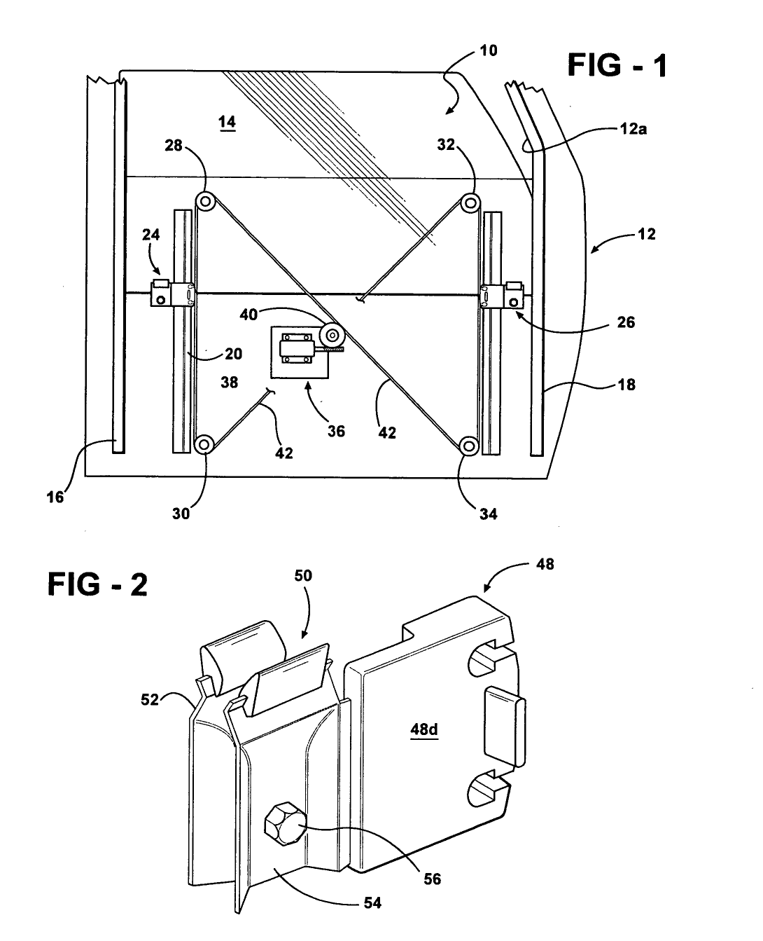

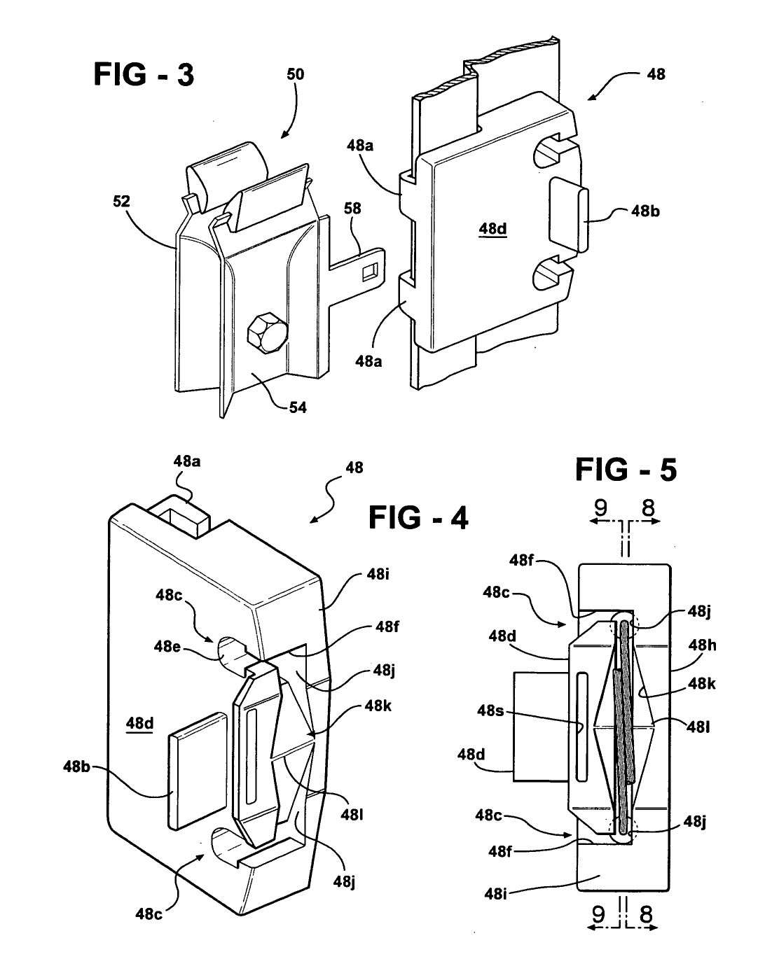

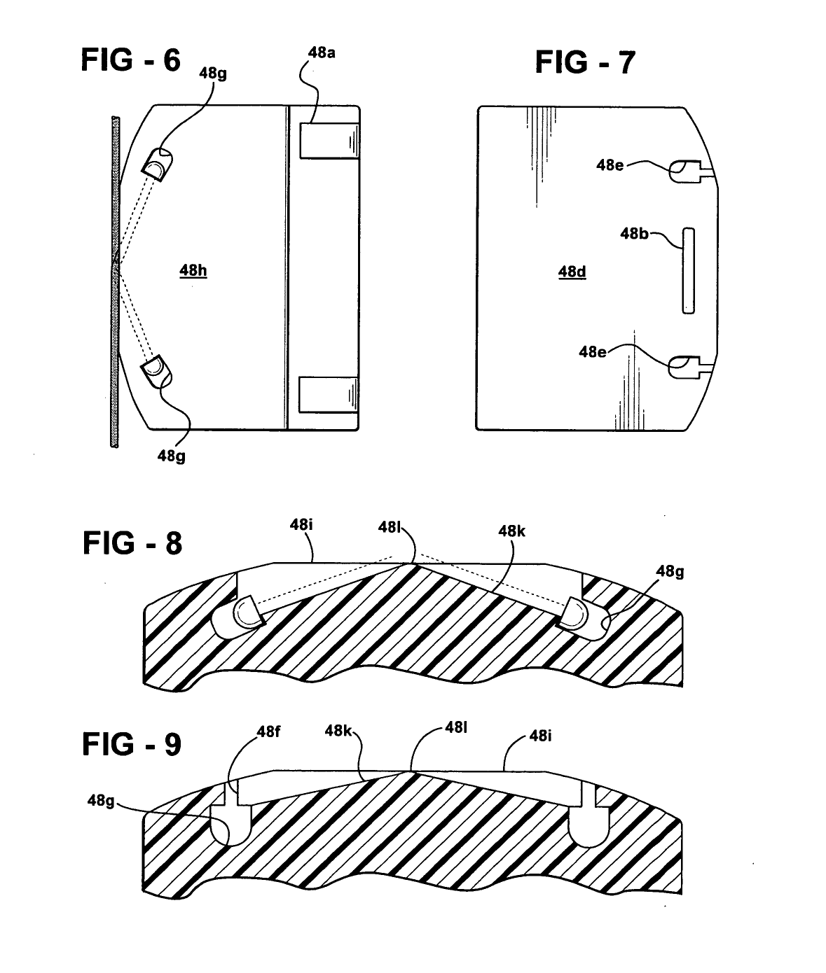

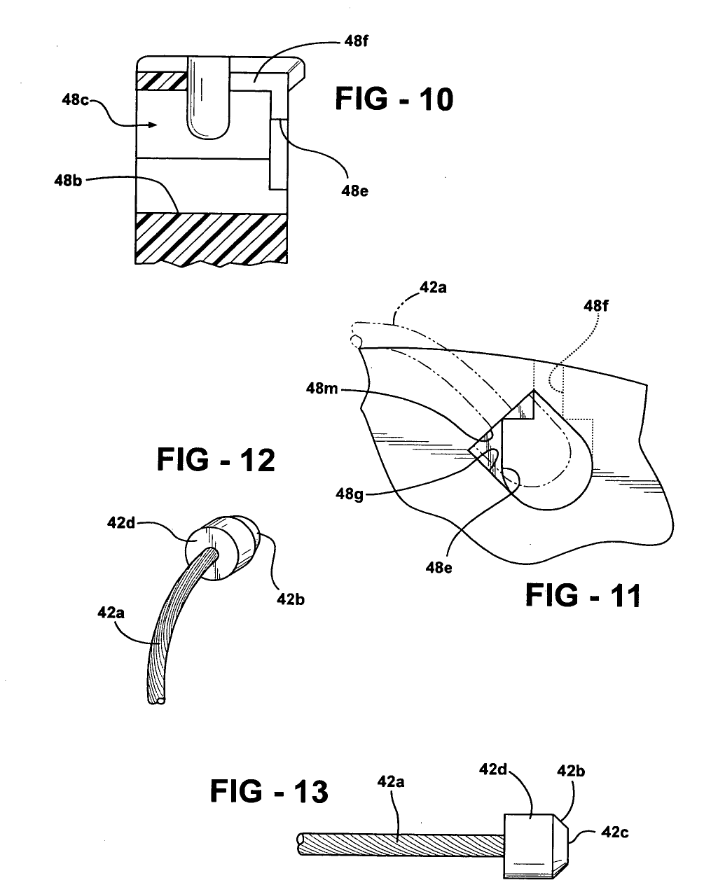

The window regulator 10 of the invention is seen in FIG. 1 in association with a motor vehicle door assembly 12 defining a window opening 12a and including a window glass 14 sliding in left and right guide rails 16 and 18 positioned within the hollow of the door.

Regulator 10 includes left and right rails 20 and 22; left and right window glass carrier assemblies 24 and 26 mounted for slidable vertical movement along the respective rails; pulleys 28, 30, 32 and 34 suitably mounted on the upper and lower ends of the rails; a motor drive assembly 36 suitably mounted within the door and including a motor 38 driving a drum 40; and first and second cables 42/42.

Each carrier assembly 24/26 includes a slide 48 and a clamp assembly 50. Each slide 48 is formed of a suitable plastic material such for example as acetone and has a generally block configuration. A pair of tabs 48a on the inboard face of the slide coact to define an L-shaped channel for receipt of a lip 20a/22a of the tracks 20/22 whereby to mount the slides 48 for vertical up and down movement along the tracks 20/22.

Each clamp 50 is formed of two metallic clamp members 52 and 54 secured together as by a screw 56 and one of the clamp members includes a tongue 58 which may be received with a snap fit in a groove 48s in slide 48 to facilitate the assembly of the clamp to the slide to form the carrier assembly. It will be understood that the clamp members 52 and 54 clampingly engage the lower edge 14a of the window glass 14 so that upward and downward sliding movement of the slides on the tracks 20/22 has the effect of raising and lowering the window glass with a tab 48b on each slide assisting in supporting the lower edge of the glass.

Each cable 42 includes a cable body 42a and a cable head 42b at each end of the cable body. Each head has a generally cylindrical transverse cross-sectional configuration and includes a dome portion 42c giving the head a domed configuration in longitudinal cross-section.

Each slide 48 includes upper and lower receptacles 48c sized to accommodate the head 42b of a cable end. Each receptacle 48c opens in the outboard face 48d of the slide in a dome shaped cross-sectional configuration 48e which coacts with a slot 48f to allow the head 42b of a cable end to be passed through the opening 48e while allowing the cable end to pass through the slot 48f. Toward the center of the slide, the receptacle transmutes into a dome shaped cross-sectional configuration portion 48g that is cocked with respect to the opening 48e. To simplify the molding process, and as seen in FIG. 6, the cocked dome shaped configuration 48g actually opens in the inboard face 48h of the slide. The end face 48i of the slide has a generally convex configuration and defines a cable exit 48j communicating with each receptacle portion 48g and further defines a rhombus shaped groove 48k interconnecting the exits 48j/48j. Groove 48k varies in depth with respect to end face 48i and specifically is deepest proximate the juncture with cable exits 48j and is shallowest at the apex 481 of the groove.

In use, a cable head 42b is passed through each opening 48e with the cable body 42a passing through the respective slot 48f until the cable head reaches the internal portion 48g of the respective receptacle where the cable may rotate or cock to the position best seen in FIG. 11 to seat the annular underface 42d of the cable head against receptacle surface 48m and direct the cable body 42a through the respective exit 48j to allow it to lay out in the rhombus groove 42k. As best seen in FIG. 5, whether the cable body 42a of the cable end received in the upper receptacle passes to the right or left of the cable body of the cable end received in the lower receptacle is not significant and, specifically, the vertically upwardly extending upper cable end and the vertically downwardly extending lower cable end may pass each other in either left/right or right/left mix without substantial displacement of either cable end from its natural vertical position and without creating any significant interference between the cable ends.

As a result, the carrier of the invention is not “handed” and may be used for left and right and front and rear applications in a motor vehicle and, further, the invention carrier is essentially idiot proof in that there is no way that the upper cable end and the lower cable end can be mixed up and mis-installed as in prior art constructions.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A window regulator for raising and lowering a window glass in a motor vehicle comprising a vertical rail defining a vertical track, a glass carrier adapted to receive a lower edge of the window glass and mounted for vertical sliding movement along the track, and a cable having an upper end terminating in an enlarged head and a lower end terminating in an enlarged head, the carrier having a lower receptacle proximate a lower region of the carrier receiving the head of the upper cable end with the upper cable and extending vertically upwardly therefrom, whereby upward pulling movement on the upper cable end moves the cable upwardly along the track, and an upper receptacle proximate an upper region of the carrier receiving the head of the lower cable end with the lower cable end extending vertically downwardly therefrom, whereby downward pulling movement on the lower cable end moves the carrier downwardly along the track, characterized in that:
each receptacle includes a cable exit through which the cable end leaves the receptacle with the cable head positioned in the receptacle; and
the cable exits of the upper and lower receptacles are vertically aligned.

2. A window regulator according to claim 1, wherein the carrier further includes a cable guide groove interconnecting the upper and lower receptacle exits.

3. A window regulator according to claim 2, wherein the cable guide groove has a rhombus configuration.

4. A window regulator according to claim 3, wherein the cable guide groove, in side elevation, has a convex configuration.

5. A window regulator for raising and lowering a window glass of a motor vehicle comprising a vertical rail defining a vertical track, a glass carrier adapted to receive a lower edge of the window glass and mounted for vertical sliding movement along the track, and a cable having an upper end terminating in an enlarged head and a lower end terminating in an enlarged head, the carrier having a lower receptacle proximate the lower region of the carrier receiving the head of the upper cable with the upper cable end extending vertically upwardly therefrom, whereby upward pulling movement on the upper cable end moves the carrier upwardly along the track, and an upper receptacle proximate an upper region of the carrier receiving the head of the lower cable end with the lower cable end extending vertically downwardly therefrom, whereby downward pulling movement on the lower cable end moves the carrier downwardly along the track, characterized in that:
the vertically upwardly extending upper cable end and the vertically downwardly extending lower cable end are vertically aligned, whereby they may pass each other in either left/right or right/left mix without substantial displacement of either cable end from its natural vertical position.

6. A window regulator according to claim 5, wherein the carrier further includes a vertical cable guide groove interconnecting the upper and lower receptacles.

7. A window regular according to claim 6, wherein the cable guide groove has a rhombus configuration.

8. A window regulator according to claim 6, wherein the guide groove, in side elevation, has a convex configuration.
